(19) United States
(12) Patent Application Publication
(10) Pub. No.: US 2003/0074461 A1
(43) Pub. Date: Apr. 17, 2003

(54) Method of mapping names or identifiers to telecommunications network resource locations

(75) Inventors: Maynard J-Lon Kang, Singapore (SG); Ching Hong Seng, Johor (MY); Wei Lim Tan, Perak (MY)

Correspondence Address: BEYER WEAVER & THOMAS LLP, P.O. BOX 778, BERKELEY, CA, 94704-0778, US

(73) Assignee: i-DNS.net International Pte. Ltd., Singapore (SG)

(21) Appl. No.: 09/974,187

(22) Filed: Oct. 9, 2001

(51) Int. Cl. G06F 15/16

(52) U.S. Cl. 709/230; 709/245

(57) ABSTRACT

A method of retrieving a tel URL regarding a first communication node. The method includes receiving a text identifier corresponding to the first communication node from a user, sending a query including the text identifier to a second communication node capable of resolving the query, receiving a response from the second communication node, and retrieving the tel URL from a resource record provided with the response.

### BACKGROUND OF THE INVENTION

The invention relates to communication methods and systems, and specifically to methods and systems for retrieving a target party's information through a server.

As the use of interconnected networks, particularly the Internet, has become increasingly prevalent with more nodes being connected each day, the amount of information and resources coming online via these interconnected networks is growing at an even more spectacular rate, far outstripping the growth of the network itself.

Most of these resources may be described in a way specific to the fundamental architecture of the network itself, where the locations of these resources are usually referenced by node addresses such as an Internet IP Address (e.g., 203.126.226.111), or an E.164 telephone number (e.g., +1 650 566 9020).

Devices connected to the network have little or no problem dealing with the manner in which network resources are referenced described above. However, human beings who attempt to access information and resources on the network often have difficulties in dealing with this archaic convention as this is not intuitive to the manner in which human beings reference resources in the first place. This was recognized very early on with respect to IP Addresses. For this reason, early Internet researchers developed the Domain Name System (DNS). DNS provides easy to remember domain names that are resolved by name servers, which return IP Addresses associated with the domain names.

For example, an Internet user who wishes to correspond by email with James Seng may key in (or select) jseng@i-dns.net. The user's computer in conjunction with the names servers of the Domain Name System will return the IP Address of James Seng's computer. The user's computer can then use that address to initiate a TCP/IP connection with James Seng's computer.

But aside from IP Addresses, many other types of numeric (or other machine oriented) information associated with network devices is not so easily retrieved. As such, it becomes increasingly necessary to devise a system that allows human beings to reference the vast array of network resources in the most natural way possible, which would be via the use of names or identifiers.

### SUMMARY OF THE INVENTION

Various embodiments of the present invention provide interconnected networks with a method of mapping names and identifiers in a universal, constant and deterministic fashion to network resource locations, making it easier for human beings to reference these network resources as they would not have to remember complicated locators native to the network architecture.

Specifically, various embodiments of the present invention enable the user to retrieve a target party's telephone number by inputting the party's name or identifier (e.g., a domain name) into an interface device. In a specific embodiment, the interface device receives the identifier, converts the identifier into a corresponding domain name (if not already in that form), and sends the domain name to a DNS server. The DNS server resolves the domain name, retrieves a naming authority pointer resource record (NAPTR RR) corresponding to the identifier, and sends the NAPTR RR back to the interface device. The interface device receives the NAPTR RR, retrieves a tel URL from the NAPTR RR, and places a telephone call by dialing the telephone number included in the tel URL.

In this embodiment of the present invention, the Internet Domain Name System (DNS) protocol is used to query and retrieve the location of a telecommunications node (ITU-T E.164 telephone number) within an interconnected network. Specifically, software embedded in the interface device (i.e., device connected to the network that the human directly interacts with) sends a DNS query with the requested name or identifier encapsulated within to a DNS server. The DNS server then attempts to match the name or identifier in the query to resource records (RR) that it can lookup in its own database (or cache) or find in a recursive DNS search. If there is a match, the DNS server then retrieves the resource record and sends a response with the E.164 telephone number back to the software embedded in the interface device.

In another specific embodiment, the HyperText Transfer Protocol (HTTP) is used to query and retrieve the location of a telecommunications node within an interconnected network. Specifically, software embedded in the interface device sends an HTTP query with the requested name or identifier encapsulated within to an HTTP server. The HTTP server then processes the query by extracting the requested name or identifier and initiating a DNS query as specified in the foregoing paragraph with the aforesaid name or identifier as its parameters. Upon receiving a response from the DNS server, the HTTP server then extracts the E.164 telephone number from the response and sends it to the client software in the interface device within the same HTTP transaction.

In still another specific embodiment, the Short Message Service (SMS) protocol is used to query and retrieve the location of a telecommunications node. Specifically, software embedded in the interface device (e.g., a cellular telephone or pager) sends an SMS message with the requested name or identifier encapsulated within to another node on the telecommunications network. Software embedded in the receiving node then processes the message by extracting the requested name or identifier from the SMS message and initiating a DNS query as specified above with the aforesaid name or identifier as its parameters. Upon receiving a response from the DNS server, the software on the receiving node then extracts the E.164 telephone number from the response and sends another SMS message back to the interface device with the E.164 number contained within.

A further understanding of the nature and advantages of the present invention may be realized by reference to the remaining portions of the specification and the drawings.

### BRIEF DESCRIPTION OF THE DRAWING

The invention, together with further objects and advantages thereof, may best be understood by reference to the following description taken in conjunction with the accompanying drawings in which:

FIG. 1 is a schematic diagram of a network including an interface device for use with a first embodiment of the present invention.

FIG. 2 is a process flow diagram depicting retrieval of telephone information from a domain name server (DNS) server, in accordance with the first embodiment of the present invention.

FIG. 3 is a schematic diagram of a network including an HTTP server and a user's interface device for use with a second embodiment of the present invention.

FIG. 4 is a process flow diagram depicting retrieval of telephone information from a DNS server, in accordance with the second embodiment of the present invention.

FIG. 5 is a schematic diagram of a network including an SMS receiving node and a user's interface device for use with a third embodiment of the present invention.

FIG. 6 is a process flow diagram depicting retrieval of telephone information from a DNS server, in accordance with the third embodiment of the present invention.

FIG. 7 is a computer system used for implementing embodiments of the present invention.

### DETAILED DESCRIPTION OF SPECIFIC EMBODIMENTS

Various embodiments of the present invention will now be described in detail with reference to the drawings, wherein like elements are referred to with like reference labels throughout.

Various embodiments of the present invention enable a user to retrieve a target party's telephone number by designating the party's identifier. In one favored embodiment, a user's interface device converts the identifier into a domain name (unless the identifier is itself a domain name). A DNS server subsequently receives the domain name, and retrieves a naming authority pointer resource record corresponding to the domain name. This resource record contains a tel URL. The DNS server then sends the resource record to the interface device or a proxy for the interface device. The interface device or proxy retrieves the tel URL from the resource record. Based on the tel URL, the interface device utilizes the telephone number information to, for example, place a call to the party, store the telephone number internally, send the telephone number to another node, or take other action.

Note that most embodiments described herein make use of the Domain Name System to locate resource records containing tel URLs. The invention is not limited to the Domain Name System or the associated DNS resource records. In alternative embodiments, the tel URLs are located on particular network nodes that may be identified by a retrieval mechanism other than DNS. Examples of such alternative retrieval mechanisms include Common Name Resolution Protocol (CNRP), Lightweight Directory Access Protocol (LDAP), and X.500 DAP (Directory Access Protocol).

### First Embodiment

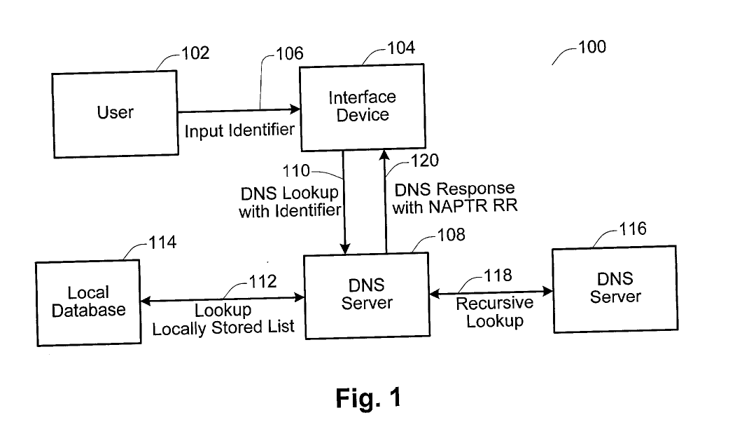

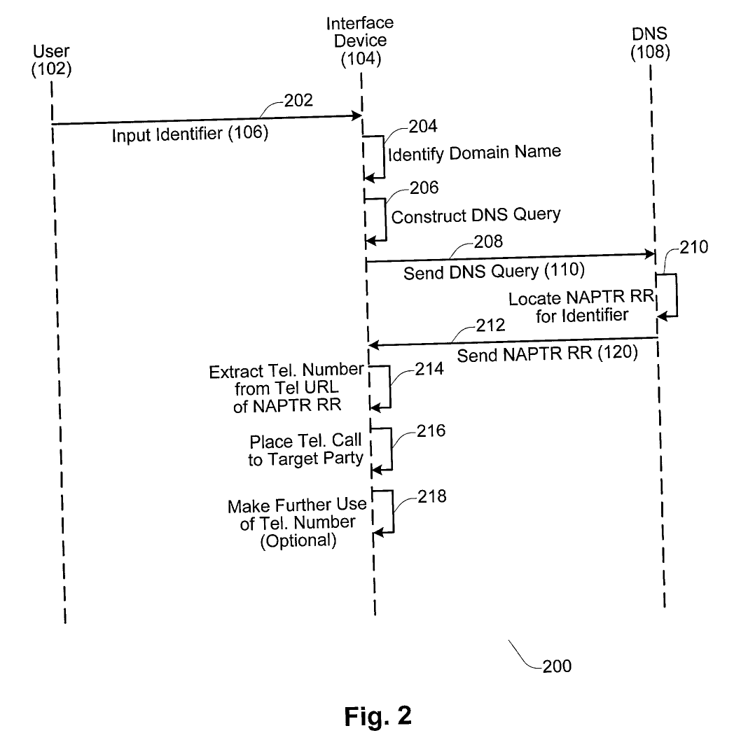

FIG. 1 is a schematic diagram of a network 100 including an interface device for use with a first embodiment of the present invention. FIG. 2 is a process flow diagram 200 depicting retrieval of telephone information from a domain name server (DNS) server, in accordance with the first embodiment of the present invention. FIGS. 1 and 2 will be described together in order to illustrate the invention.

In some exemplary situations for which some embodiments of the present invention are utilized, a human user 102 of an interface device 104 wishes to place a telephone call to someone (a “target party”) whose telephone number is not known to the user 102. In some other exemplary situations, the user 102 wishes to retrieve and store the target party's telephone number. Embodiments of the present invention corresponding to this first embodiment enable the user 102 to retrieve a telephone number by inputting an identifier corresponding to the telephone number into the interface device 104 as a key to the telephone number.

The user 102 interacts with the interface device 104 in order to retrieve a telephone number of the target party. This is represented at 202 in FIG. 2, where the user 102 inputs an identifier 106 designating the target party into the interface device 104 by, for example, typing the identifier 106 from a keyboard, or selecting the identifier 106 among an identifier list containing a plurality of stored identifiers. The method of inputting the identifier 106 may be any suitable way including mouse or keyboard manipulations or simply talking to a microphone connected to a processor with speech recognition capability, and the like.

In this specification, an “identifier” may be any suitable text which is associated with the target party, and can be used as a key to the target party's telephone number when retrieving the number from a DNS server. Such an identifier includes an actual name (e.g., “James Seng”), a label (e.g., “JamesSeng” or James_Seng), a Uniform Resource Locator (“URL,” e.g., “jseng@i-dns.net”), a symbol, and the like.

The interface device 104 is capable of communicating with a DNS server 108 via a network. In this specification, the term “network” includes wired and wireless networks such as the Internet, various forms of intranet (e.g., a local area network, a wide area network), and the like. The interface device 104 is capable of sending queries to and receiving responses from the DNS server 108 in the DNS protocol described in Internet RFC 1035, which is incorporated herein by reference for all purposes.

In some embodiments, the interface device 104 includes or is closely associated with a standard software program enabling the interface device 104 to communicate with the DNS server 108, which is called a “resolver” program. The interface device 104 may be implemented with a workstation or personal computer available from, for example, Dell Computer Corporation or Compaq Computer Corporation, an i-mode cellular phone available from, for example, NTT DoCoMo, Inc. in Japan, a handheld personal digital assistant (PDA) available from, for example, Palm Inc., or the like.

Upon receiving the identifier from the user 102, the interface device 104 performs one or more operations as depicted in FIG. 2. In the first of these operations (204), the interface device 104 obtains a domain name corresponding to the identifier based on a predetermined relationship between the identifier and the corresponding domain name. Such a relationship is typically maintained in a memory device of the interface device 104 as a conversion table. For example, such a conversion table associates the identifier (e.g., “JamesSeng”) with the corresponding domain name (e.g., “jseng@i-dns.net”). Of course, if the identifier provided by the user is itself a domain name, then the conversion is unnecessary and 204 is not performed.

At 206, the interface device 104 constructs a DNS query 110 including the domain name (e.g., “jseng@i-dns.net”) corresponding to the identifier input by the user 102, and a query for resource records of type “NAPTR RR.” The interface device 104 sends the DNS query 110 to the DNS server 108 as described in RFC 1035. At 208, the interface device 104 submits the DNS query 110 to the DNS server 108.

At 210, the DNS server 108 locates a naming authority pointer (NAPTR) resource record (RR) for the domain name of the query 110 by the conventional DNS resolution technique. The format and use of an NAPTR RR is described in Internet RFC 2915, which is incorporated herein by reference for all purposes. In this invention, the NAPTR resource record is specially constructed to include the target party's telephone number, typically in the form of a tel URL. The DNS server 108 may retrieve the NAPTR RR by a local lookup 112 in a database 114 which is locally contained in the DNS server 108. In such cases, name server 108 is the “authoritative” name server for domain name in question. Alternatively, the DNS server 108 may retrieve the NAPTR RR from another DNS server 116 by at least one set of DNS query and response 118 in a method commonly known as a recursive DNS lookup. In still another approach, the resource record is cached locally in name server 108, even though the server is not authoritative for the domain name. Resource records have a time to live (TTL) value. After the resource record times out, it is deleted from the cache of server 108.

At 212, when the NAPTR RR for the query 110 is successfully retrieved, the DNS server 108 returns a response 120 including the target party's telephone number to the interface device 104 in the DNS protocol. The response 120 includes the target party's telephone number preferably in the form of a “tel” URL, as described in Internet RFC 2806, which is incorporated herein by reference for all purposes. A “tel” URL is, for example, “tel:+1-650-5669020” or “tel:0016505669020.”

At 214, upon receiving the DNS response 120, the interface device 104 extracts the “tel” URL from the received NAPTR RR, and generates the target party's telephone number in the E.164 standard by omitting “tel:” and other symbol such as “+” and “-” from the “tel” URL. At 216, the interface device 104 places a telephone call to the target party by dialing the E.164 telephone number. At 218, the interface device 104 may further process or utilize the telephone number obtained by 214 for other applications. For example, the interface device 104 may store the E.164 telephone number in a memory device provided in the interface device 104 for later use.

Although the interface device 104 receives the tel URL in an NAPTR RR as defined in RFC 2915 (per the above-described specific embodiment), the interface device 104 may receive the tel URL in another suitable resource record format. As is known to those of skill in the art, various types of resource records can be defined and used. In any such case, the new resource record format must allow for embedding the target party's telephone number in the resource record.

### Second Embodiment

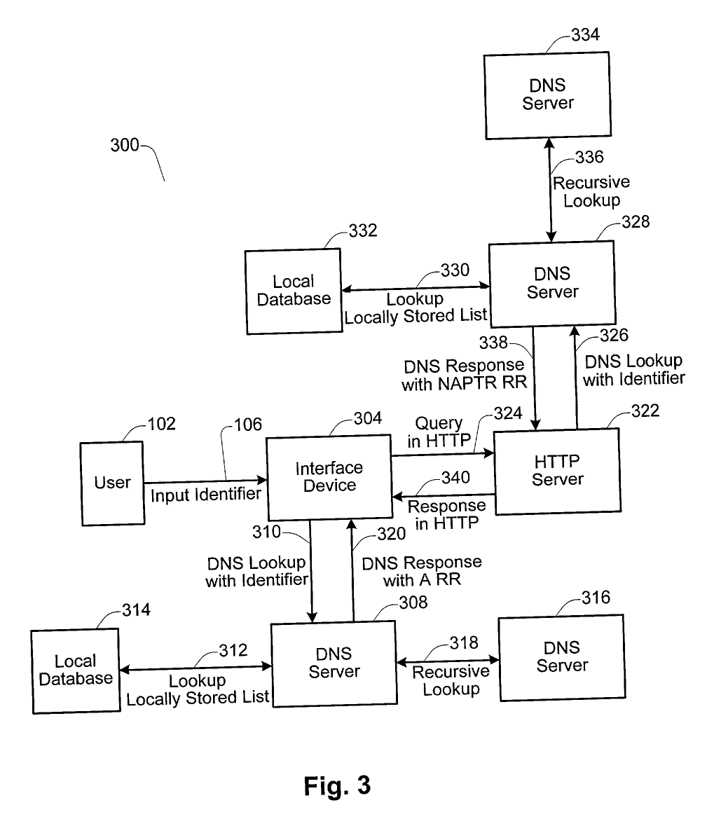

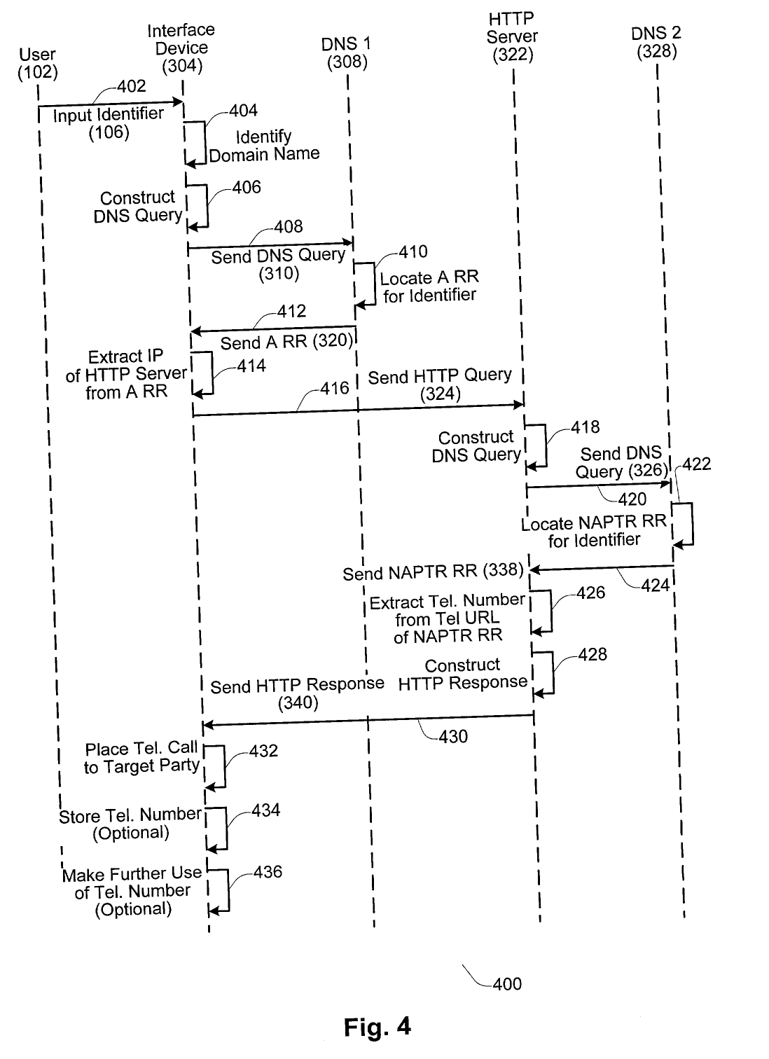

FIGS. 3 and 4 together depict a second embodiment of the invention. FIG. 3 is a schematic diagram of a network 300 including an interface device for use with the second embodiment of the present invention. FIG. 4 is a process flow diagram 400 depicting retrieval of telephone information from a DNS server, in accordance with the second embodiment of the present invention.

Similar to the first embodiment, the user 102 wishes to, for example, place a telephone call to the target party and/or store the target party's telephone number. Embodiments of the present invention including this second embodiment enable the user 102 to retrieve a telephone number by inputting an identifier corresponding to the phone number into an interface device 304 as a key to the phone number even when the interface device 304 does not have the capability (referred to as 214 in FIG. 2) of extracting the “tel” URL from the received NAPTR RR.

The user 102 interacts with the interface device 304 in order to retrieve a telephone number of the target party. At 402 in FIG. 4, the user 102 inputs the identifier 106 designating the target party into the interface device 304 by, for example, typing the identifier 106 from a keyboard, or selecting the identifier 106 among an identifier list containing a plurality of identifiers. As with the first embodiment, the method of inputting the identifier 106 may be any suitable way including simply talking to a microphone connected to a processor with speech recognition capability, and the like.

The interface device 304 is capable of communicating with a DNS server 308 via a network. The interface device 304 is capable of sending queries to and receiving responses from the DNS server 308 in the DNS protocol described in Internet RFC 1035.

As with the first embodiment, the interface device 304 may include a resolver. And as before, the interface device 304 may be implemented on a workstation or a personal computer available from, for example, Dell Computer Corporation or Compaq Computer Corporation, an i-mode cellular phone available from, for example, NTT DoCoMo, Inc. in Japan, a handheld PDA available from, for example, Palm Inc., or the like.

At 404, upon receiving the identifier from the user 102, the interface device 304 identifies a domain name corresponding to the identifier as described above. For example, the interface device may receive JamesSeng as the identifier and then locate the corresponding domain name (e.g., “jseng@i-dns.net”).

At 406, the interface device 304 constructs a DNS query 310 including the domain name corresponding to the identifier input by the user 102. The query is of type “Address” (A). Per standard DNS protocol, such queries require that only A type resource records be returned. These are resource records containing IP Addresses associated with the domain name in the query. At 408, the interface device 304 sends the DNS query 310 to the DNS server 308.

At 410, the DNS server 308 locates an A type resource record for the domain name of the query 310 by the conventional DNS resolution technique. In this embodiment, the A type resource record includes the IP address of an HTTP server 322 which the interface device 304 will contact later for an NAPTR RR containing the target party's telephone number. The DNS server 308 may retrieve the A type resource record by a local lookup 312 in a database 314 which is locally contained in the DNS server 308 where software of the DNS server 308 resides. Alternatively, the DNS server 308 may retrieve the A type resource record from another DNS server 316 via a separate DNS query in a recursive DNS lookups 318.

At 412, when the A type resource record for the query 110 is successfully retrieved, the DNS server 308 returns a response 320 to the interface device 304 using the DNS protocol. As indicated, the response 320 includes the A RR with the IP address of the HTTP server 322. The A RR is provided in a format of, for example, “jseng@i-dns.net. A 12.34.56.78” as described in Internet RFC 1035.

Note that in this embodiment, the authoritative name server for jseng@i-dns.net provides resource records that link that domain name not with IP address for James Seng's network device, but for the HTTP server 308. This is a somewhat unconventional use of A type resource records, but it is entirely consistent with the DNS protocol.

At 414, upon receiving the DNS response 320, the interface device 304 extracts the IP address of the HTTP server 322 from the received DNS response 320, and establishes HTTP connection with the HTTP server 322 using the extracted IP address from the response 320. In this specific embodiment, the connection is made in the HTTP 1.1 protocol as described in RFC 2068, which is incorporated herein by reference for all purposes.

At 416, the interface device 304 sends a query 324 specifying the identifier (e.g., “jseng@i-dns.net”) to the HTTP server 322 in the HTTP protocol for retrieving the NAPTR RR corresponding to the identifier. The query 324 includes any suitable command such as a “GET” command in the HTTP protocol, or the like.

Upon receiving the query 324, at 418, the HTTP server 322 constructs a DNS query 326 including the domain name (e.g., “jseng@i-dns.net”) corresponding to the identifier input by the user 102. Query 326 has a query type of “NAPTR RR.” At 420, the HTTP server 322 sends the DNS query 326 to the DNS server 328 per the protocol of RFC 1035.

At 422, the DNS server 328 locates a NAPTR RR for the domain name of the query 326 by the conventional DNS resolution technique. The NAPTR RR described in Internet RFC 2915 includes the target party's telephone number. As with all DNS resolutions, the DNS server 328 may retrieve the NAPTR RR by a local lookup 330 in a database 332 which is locally contained in the DNS server 328 or, alternatively, from another DNS server 334 by recursive DNS lookups.

At 424, when the NAPTR RR for the query 326 is successfully retrieved, the DNS server 328 returns a response 338 including the target party's telephone number to the HTTP server 322 in the DNS protocol. The response 338 includes the target party's telephone number in the form of a “tel” URL, as described in Internet RFC 2806, as mentioned above.

At 426, upon receiving the DNS response 338, the HTTP server 322 extracts the “tel” URL from the received NAPTR RR, and generates the target party's telephone number in the E. 164 standard by omitting “tel:” and other symbol such as “+” and “-” from the “tel” URL. At 428, the HTTP server 322 constructs a response 340 to reply the query 324 in the HTTP protocol. At 430, the HTTP server 322 sends the response 340 specifying the target party's telephone number corresponding to the identifier to the interface device 304 in the HTTP protocol.

At 432, the interface device 304 places a telephone call to the target party by dialing the E.164 telephone number obtained by the response 340. Further, at 434, the interface device 304 may store the E.164 telephone number in a memory device provided in the interface device 304 for later use. At 436, the interface device 304 may further process or utilize the telephone number obtained by 432 for other applications.

In the above-described embodiment, the interface device 304 first retrieves the IP address of the HTTP server 322 by the DNS query 310 to the DNS server 308, and then retrieves the NAPTR RR from the HTTP server 322. However, it should be appreciated that the interface device 304 may directly communicate with the HTTP server 322 without first using the DNS query 310. This may occur when the interface device 304 already has the IP address of the HTTP server 322. In some cases, interface device 304 may treat HTTP server 322 as its default server—for a browser for example. In such a case, at 404, upon receiving the identifier from the user 102, the interface device 304 obtains an IP address of the HTTP server 322 (as corresponding to the identifier based on a predetermined relationship between the identifier and the corresponding IP address of the HTTP server 322). Then, the interface device 304 establishes HTTP connection with the HTTP server 322 using the obtained IP address skipping a part of the process indicated by 406-414.

Although the DNS servers 308 and 328 are separately illustrated in the above description, there is a chance that the HTTP server 322 sends the DNS query 326 to the DNS server 308 rather than the DNS server 328. (Viewing this another way, DNS servers 308 and 328 may be one and the same.) Thus, the above description referring to FIG. 3 should not be deemed to limit this specific embodiment to a case where the HTTP server 322 sends the query 326 to a physically separate DNS server other than the DNS server 308.

Finally, although the interface device 104 receives a DNS response including an NAPTR RR defined in RFC 2915 from the DNS server 108 in the above-described specific embodiment, the interface device 104 may receive a response including any other suitable form of resource record which indicates the target party's telephone number. In such a case, the DNS server 108 allows other types of RRs to be defined in a format where the target party's telephone number information is embedded.

### Third Embodiment

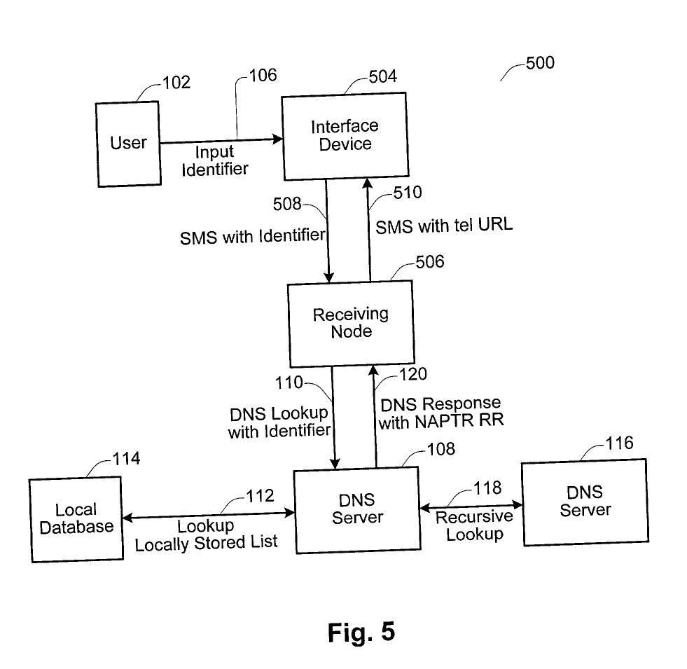

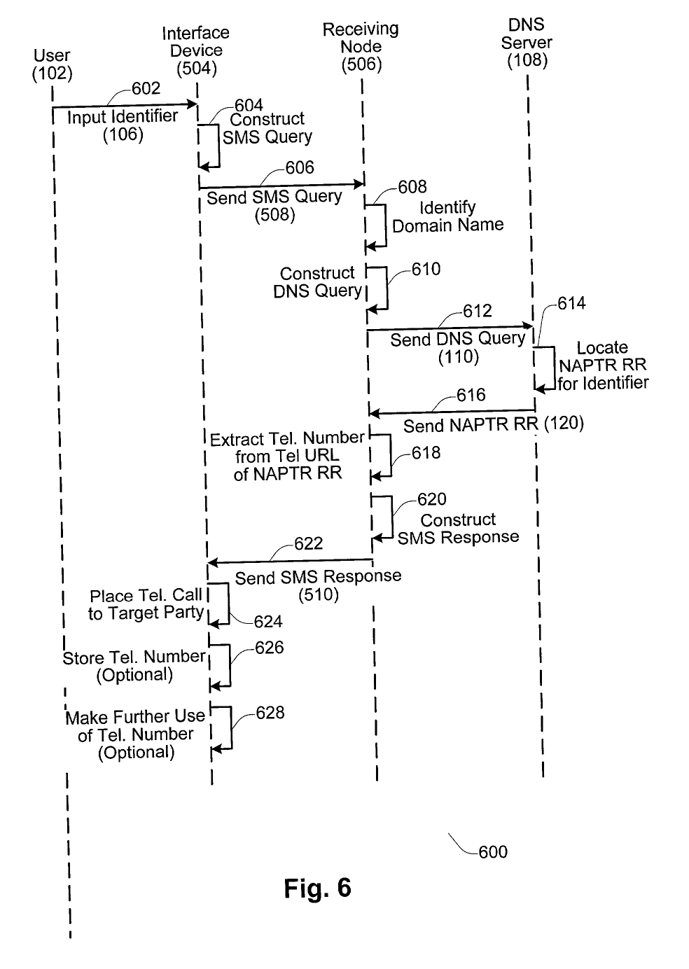

FIGS. 5 and 6 together depict a third embodiment of this invention. FIG. 5 is a schematic diagram of a network 500 including an interface device for use with the third embodiment of the present invention. FIG. 6 is a process flow diagram 600 depicting retrieval of telephone information from a DNS server, in accordance with the third embodiment of the present invention.

Similar to the first and second embodiments, the user 102 wishes to, for example, place a telephone call to the target party and/or store the target party's telephone number. Embodiments of the present invention including this third embodiment enable the user 102 to retrieve a telephone number by inputting an identifier corresponding to the phone number into an interface device 504 as a key to the phone number even when the interface device 504 does not have the capability of initiating communication with a DNS server or an HTTP server (via 208, 408, or 416, for example).

The user 102 interacts with the interface device 504 in order to retrieve a telephone number of the target party. At 602 in FIG. 6, the user 102 inputs an identifier 106 designating the target party into the interface device 504 by, for example, typing the identifier 106 from a keyboard, or selecting the identifier 106 among an identifier list containing a plurality of identifiers, or talking into a microphone.

The interface device 504 is capable of communicating with a receiving node 506 via a network. The interface device 504 is coupled to the receiving node 506 by any suitable wireless medium which transports queries and responses including Global System for Mobile Communications (GSM), Code Division Multiple Access (CDMA), Time Division Multiple Access (TDMA), Advanced Mobile Phone System (AMPS), frequency modulation (FM) communication systems, and the like. In this third embodiment, the interface device 504 is capable of sending queries to and receiving responses from the receiving node 506 in the Short Message Service (SMS) protocol as described in “Smart Messaging Specification,” v1.0.0 Tech rep, Nokia 1997, incorporated herein by reference for all purposes. It should be appreciated that other suitable protocols may be utilized for coupling the interface device 504 to the receiving node 506.

In this specific embodiment, the interface device 504 is an i-mode cellular phone available from, for example, NTT DoCoMo, Inc. in Japan, a handheld personal digital assistant (PDA) available from, for example, Palm Inc., or the like. However, alternatively, the interface device 504 may be implemented with a personal computer available from, for example, Dell Computer Corporation or Compaq Computer Corporation, or the like.

At 604, upon receiving the identifier from the user 102, the interface device 504 constructs a query 508 including the identifier 106 (e.g., “JamesSeng” or “jseng@i-dns.net”). At 606, the interface device 504 sends the query 508 to the receiving node 506 in the SMS protocol. The receiving node 506 is, for example, a wireless base station of a telephone company which accommodates mobile stations including the interface device 504. At 608, the receiving node 506 obtains a domain name corresponding to the identifier (assuming that the identifier is not the domain name itself) based on a predetermined relationship between the identifier and the corresponding domain name. Such a relationship is typically maintained in a memory device provided in the receiving node 506 as a conversion table. For example, such a conversion table associates the identifier (e.g., “JamesSeng”) with the corresponding domain name (e.g., “jseng@i-dns.net”).

At 610, the receiving node 506 constructs the DNS query 110 including the domain name (e.g., “jseng@i-dns.net”) corresponding to the identifier input by the user 102, and a query type of “NAPTR RR.” The receiving node 506 sends the DNS query 110 to the DNS server 108 as described in RFC 1035. At 612, the receiving node 506 submits the DNS query 110 to the DNS server 108.

At 614, the DNS server 108 locates a NAPTR RR (RFC 2915) for the domain name of the query 110 by the conventional DNS resolution technique. As with the other embodiments, the NAPTR RR includes the target party's telephone number. As in all embodiments, the DNS server 108 may retrieve the NAPTR RR by the local lookup 112 in the database 114 or from another DNS server 116 by at least one set of DNS query and response 118 or by retrieving the RR from a local cache.

At 616, when the NAPTR RR for the query 110 is successfully retrieved, the DNS server 108 returns the resource record in a response 120 to the receiving node 506 using the DNS protocol. The resource record in response 120 includes the target party's telephone number in the form of a “tel” URL, as described in Internet RFC 2806.

At 618, upon receiving the DNS response 120, the receiving node 506 extracts the “tel” URL from the received NAPTR RR, and generates the target party's telephone number in the E.164 standard by omitting “tel:” and other symbol such as “+” and “-” from the “tel” URL. At 620, upon generating the target party's telephone number, the receiving node 506 constructs a response 510 including the telephone number. At 622, the receiving node 506 sends the response 510 to the interface device 504 in the SMS protocol.

At 624, the interface device 504 places a telephone call to the target party by dialing the E.164 telephone number. Further, at 626, the interface device 504 may store the E.164 telephone number in a memory device provided in the interface device 104 for later use. At 628, the interface device 504 may further process or utilize the telephone number.

As with the other embodiments, the NAPTR RR may be substituted with other suitable RRs which indicates the target party's telephone number.

A specific exemplary format of a NAPTR RR used for the above-described first, second and third embodiments to provide the tel URLs in BIND format is shown below in Table 1.

TABLE 1
jseng.fone.jp.

| | |
|---|---|
| IN NAPTR 10 10 “u”“tel+I2U” | “!\hat{ }.*$!tel:+65−96387085!” |
| IN NAPTR 20 10 “u”“tel+I2U” | “!\hat{ }.*$!tel:+65−2486208!” |
| IN NAPTR 10 10 “u”“fax+I2U” | “!\hat{ }.*$!fax:+65−2486189!” |
| IN A 203.126.116.233 | |

In this specific example of the NAPTR RR, fields specifying domain, class, type, preference, order, flags and regexp are used. Each field of the NAPTR RR is shown below in Table 2.

TABLE 2
Domain=jseng.fone.jp.
Class=IN
Type=NAPTR
Order={10, 20, 10}
Preference=10
Flags=u
Regexp={“!\hat{ }.*$!tel:+65−96387085!”, “!\hat{ }.*$!tel:+65−2486208!”,
“!\hat{ }.*$!fax:+65−2486189!”}

In the above example shown in Table 1 has multiple resource records for one domain (i.e., jseng.fone.jp). The field “type=A” at the last line of the example is the IP address of the HTTP server 322 which enables the interface device 304 to access to the HTTP server 322 in the second embodiment. The preference and order values are used to designate the priority of the telephone numbers. The interface devices 104, 304 and 504 may present the user with a list of the telephone numbers sorted by the order value so that the user 102 can choose a number from the list. Alternatively, the interface devices 104, 304 and 504 may present a one number to the user 102 based on the priority. The U flag, according to the NAPTR standard, means that the client should treat a returned variable as an “absolute URI” (i.e., URL) and should not do any further resolution. For a DNS RR for specifying the location of services (DNS SRV) as described in Internet RFC 2052, treating as an absolute URI is what a NAPTR RR is originally meant to be treated.

As illustrated in Tables 1 and 2 above, the “regexp” (or “regular expression”) field is utilized to store the tel URL. However, it should be appreciated that some embodiments of the present invention may utilize other type of information designating a telephone number of the target party, including explicit E.164 representation (e.g., “+16505669020”) without using the tel URL scheme, and the ENUM representation (e.g., “0.2.0.9.6.6.5.0.5.6.1.e164.arpa”) as described in Internet RFC 2916 incorporated herein by reference for all purposes. Such information designating the telephone number of the target party may include other information such as a header, a delimiter, a trailer, or the like.

As mentioned above, in some other embodiments of the present invention, the above-described DNS protocol used for the domain name resolution technique may be substituted by other suitable protocols including (1) Common Name Resolution Protocol (CNRP) as described in http://www.ietf.org/internet-drafts/draft-ietf-cnrp-10.txt, (2) LDAP (Lightweight Directory Access Protocol) as described in Internet RFC 2251, and (3) X.500 DAP (Directory Access Protocol) as described in ITU-T Rec. X.500, “The Directory: Overview of Concepts, Model and Service” (1993), all of which are incorporated herein by reference for all purposes.

The telephone number retrieved from a resource record in the above-described specific embodiments may be substituted or supplemented with other data including a post address, an e-mail address, a URL of a web site of the target party, or the like. Such personal data may be incorporated in the regexp field of the above-described NAPTR RR.

The functionality of the embodiments of the present invention can be implemented by any combination of software and/or hardware. For example, the embodiments can be implemented in an operating system (e.g., Windows NT) kernel, in a separate user process, in a library package bound into network applications, on a specially constructed machine, or on a network interface card. In one specific embodiment of the invention, the operations performed by the embodiments of the invention are partially implemented in server software (for the name servers, receiving nodes, HTTP servers, etc. described herein). The operations are also partially implemented in client code on a device (e.g., the interface devices described herein), which is connected with the server via the network. Both components may be implemented in an operating system or in an application running on an operating system.

Some specific embodiments of the present invention relate to an apparatus and a method for retrieving the target party's tel URL. This apparatus may be specially constructed (or designed) for the required purposes, or it may be a general-purpose computer selectively activated or configured by a computer program stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method operations. The required architecture or structure for a variety of these machines will appear from the description given below.

Such programmable machine may be a network device designed to handle network traffic, such as, for example, a network server. Such network devices may have multiple network interfaces including frame relays or ISDN interfaces, for example. In an alternative embodiment, the item substitution technique of this invention may be implemented on a general-purpose network host machine such as a personal computer or workstation. Further, any or all of the functionality of the invention may be at least partially implemented on a card (e.g., an interface card) for a network device or a general-purpose computing device.

In addition, embodiments of the present invention further relate to computer program products using computer readable media that include program instructions for performing various computer-implemented operations described above. Some embodiments of the present invention relate to a computer readable product comprising a machine readable medium on which is provided data comprising an NAPTR RR, which in turn includes information designating a telephone number and an associated domain name. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as mini disks, floptical disks; and hardware devices that are specially configured to store and perform program instructions, such as ROMs (read-only memories) and RAMs (random access memories). The media may also be a transmission medium such as optical or metallic lines, wave guides, etc. including a carrier wave transmitting signals specifying the program instructions, data structures, etc. The carrier wave may be an RF (Radio Frequency) signal, an infrared ray, a microwave, and other suitable carrier. Examples of program instructions include both machine code, such as produced by a compiler, and files containing higher level code that may be executed by the computer using an interpreter. It is contemplated that such a computer program product may be distributed as a removable media with accompanying printed or electronic documentation, e.g., shrink wrapped software, preloaded with a computer system, e.g., on a system ROM or a fixed disk, or distributed from a server or electronic bulletin board over a network, e.g., the Internet or World Wide Web.

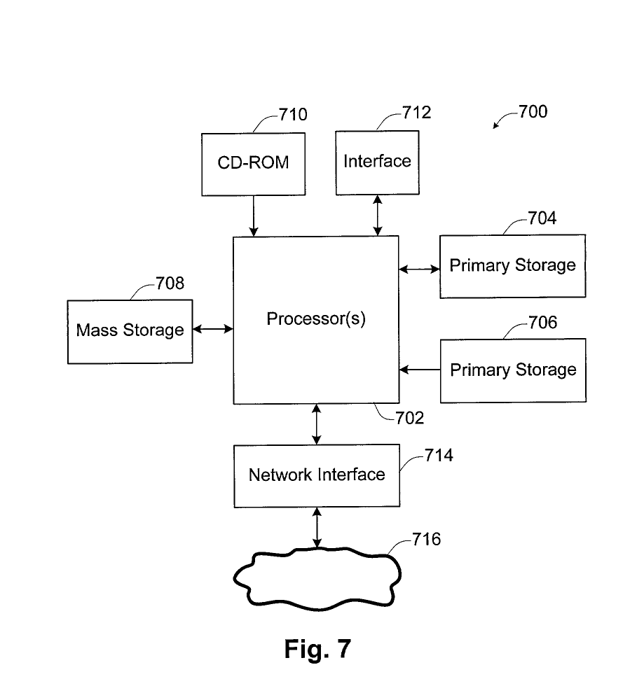

FIG. 7 illustrates a typical computer system used for implementing some embodiments of the present invention. The computer system 700 includes any number of processors 702 (also referred to as controllers, CPUs, or central processing units) that are coupled to storage devices including primary storage 704 (typically a RAM), primary storage 706 (typically a ROM). As is well known in the art, the primary storage 704 acts to transfer data and instructions bi-directionally to the CPU and primary storage 706 is used typically to transfer data and instructions in a uni-directional manner. Both of these primary storage devices may include any suitable type of the computer-readable media described above. A mass storage device 708 is also coupled bi-directionally to CPU 702, and provides additional data storage capacity and may include any of the computer-readable media described above. The mass storage device 708 may be used to store programs, data and the like and is typically a secondary storage medium such as a hard disk that is slower than primary storage. It will be appreciated that the information retained within the mass storage device 708, may, in appropriate cases, be incorporated in standard fashion as part of primary storage 704 as virtual memory. A specific mass storage device such as a CD-ROM 710 may also pass data uni-directionally to the CPU 702.

CPU 702 is also coupled to an interface 712 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to a computer or telecommunications network 716 including the Internet and/or an intranet (typically a LAN, or local area network) using a network interface as shown generally at 714. With such a network interface, it is contemplated that the CPU 702 might receive information from the network 716, or might output information to the network in the course of performing the above-described method operations. The above-described devices and materials will be familiar to those of skill in the computer hardware and software arts.

The network interface 714 is typically provided as an interface card (sometimes referred to as a “line card”). Generally, it controls the sending and receiving of data packets over the network and sometimes support other peripherals used with the computer system 700. The network interface 714 may be one of Ethernet interfaces, frame relay interfaces, cable interfaces, DSL (Digital Subscriber Line) interfaces, token ring interfaces, and the like. In addition, various very high-speed interfaces may be provided such as fast Ethernet interfaces, Gigabit Ethernet interfaces, ATM (Asynchronous Transfer Mode) interfaces, HSSIs (High-Speed Serial Interfaces), POS (Point of Sale) interfaces, FDDIs (Fiber Distributed Data Interfaces) and the like. Generally, these interfaces may include ports appropriate for communication with the appropriate media. In some cases, they may also include an independent system including a processor and system memory.

The CPU 702 may take various forms. It may include one or more general-purpose microprocessors that are selectively configured or reconfigured to implement the functions described herein. Alternatively, it may include one or more specially designed processors or microcontrollers that contain logic and/or circuitry for implementing the functions described herein. Any of the logical devices serving as CPU 702 may be designed as general purpose microprocessors, microcontrollers (sometimes simply referred to as “controllers”), ASICs (application specific integrated circuits), DSPs (digital signal processors), PLDs (programmable logic devices), FPGAs (field programmable gate arrays), and the like. They may execute instructions under the control of the hardware, firmware, software, reconfigurable hardware, combinations of these, etc.

The hardware elements described above may be configured (usually temporarily) to act as one or more software modules for performing the operations of this invention. For example, separate modules may be created from program instructions for performing the functionality of the embodiments according to the present invention as described above. The components shown in FIG. 7 are coupled separately, but any or all of them may be coupled through a common system bus (e.g., a PCI bus). In appropriate cases, a part of the hardware elements in FIG. 7 can be omitted.

Although only a few embodiments of the present invention have been described in detail, it should be understood that the present invention may be embodied in many other specific forms without departing from the spirit or scope of the invention. Therefore, it should be apparent that the above described embodiments are to be considered as illustrative and not restrictive, and the invention is not to be limited to the details given herein, but may be modified within the scope of the appended claims.

What is claimed is:

1. A method, implemented on an apparatus, of retrieving information designating a telephone number regarding a first communication node, comprising:
receiving a text identifier corresponding to the first communication node from a user;
sending a query including the text identifier to a second communication node capable of resolving the query;
receiving a response from the second communication node; and
retrieving the information from a resource record provided with the response.

2. The method of claim 1, wherein the information includes a tel URL.

3. The method of claim 1, further comprising initiating communication to the first communication node based on the information.

4. The method of claim 1, wherein the query is a DNS query; and the response is a DNS response.

5. The method of claim 4, wherein the response includes a naming authority pointer resource record.

6. The method of claim 5, wherein the query is sent, and the response is received in the Hypertext Transport Protocol.

7. The method of claim 5, wherein the query is sent, and the response is received in the Short Message Service protocol.

8. A computer program product comprising a machine readable medium on which is provided program instructions for retrieving information designating a telephone number regarding a first communication node, the program instructions specifying the following:
receiving a text identifier corresponding to the first communication node from a user;
sending a query including the text identifier to a second communication node capable of resolving the query;
receiving a response from the second communication node; and
retrieving the information from a resource record provided with the response.

9. The computer program product of claim 8, wherein the information includes a tel URL.

10. The computer program product of claim 8, further comprising initiating communication to the first communication node based on the information.

11. The computer program product of claim 8, wherein the query is a DNS query; and the response is a DNS response.

12. The computer program product of claim 11, wherein the response includes a naming authority pointer resource record.

13. The computer program product of claim 12, wherein the query is sent, and the response is received in the Hypertext Transport Protocol.

14. The computer program product of claim 12, wherein the query is sent, and the response is received in the Short Message Service protocol.

15. An apparatus for retrieving information designating a telephone number regarding a first communication node, comprising:
one or more processors; and
memory coupled to the one or more processor and configured to store program instructions for the one or more processors, the program instructions specifying the following:
receiving a text identifier corresponding to the first communication node from a user;
sending a query including the text identifier to a second communication node capable of resolving the query;
receiving a response from the second communication node; and
retrieving the information from a resource record provided with the response.

16. The apparatus of claim 15, wherein the information includes a tel URL.

17. The apparatus of claim 15, further comprising initiating communication to the first communication node based on the information.

18. The apparatus of claim 15, wherein the query is a DNS query; and the response is a DNS response.

19. The apparatus of claim 18, wherein the response includes a naming authority pointer resource record.

20. The apparatus of claim 19, wherein the query is sent, and the response is received in the Hypertext Transport Protocol.

21. The apparatus of claim 19, wherein the query is sent, and the response is received in the Short Message Service protocol.

22. A method, implemented on an apparatus, of providing information designating a telephone number regarding a first communication node, comprising:
receiving a query including a text identifier corresponding to the first communication node from a second communication node;
retrieving a resource record corresponding to the first communication node including the information; and
sending a response with the resource record including the information to the second communication node.

23. The method of claim 22, wherein the information includes a tel URL.

24. A computer program product comprising a machine readable medium on which is provided program instructions for providing information designating a telephone number regarding a first communication node, the program instructions specifying the following:
receiving a query including a text identifier corresponding to the first communication node from a second communication node;
retrieving a resource record corresponding to the first communication node including the information; and
sending a response with the resource record including the information to the second communication node.

25. The computer program product of claim 24, wherein the information includes a tel URL.

26. A computer readable product comprising a machine readable medium on which is provided data comprising:
a naming authority pointer resource record (NAPTR RR), wherein the NAPTR RR comprises information designating a telephone number and an associated domain name.

27. The computer readable product of claim 26, wherein the information includes a tel URL.

28. The computer readable product of claim 26, wherein the information is provided in a field specifying regular expression.

29. The computer readable product of claim 28, wherein the NAPTR RR further comprises fields specifying preference, order, and flags.
